(19) United States
(12) Patent Application Publication
(10) Pub. No.: US 2014/0090842 A1
(43) Pub. Date: Apr. 3, 2014

(54) Cement Compositions Comprising Deagglomerated Inorganic Nanotubes and Associated Methods

(71) Applicant: HALLIBURTON ENERGY SERVICES, INC., Houston, TX (US)

(72) Inventors: Rahul Chandrakat Patil, Maharashtra (IN); Ramesh Muthusamy, Maharashtra (IN); B. Raghava Reddy, The Woodlands, TX (US); Abhimanyu Pramod Deshpande, Maharashtra (IN); Sohini Bose, Maharashtra (IN)

(73) Assignee: HALLIBURTON ENERGY SERVICES, INC., Houston, TX (US)

(21) Appl. No.: 13/630,920

(22) Filed: Sep. 28, 2012

(51) Int. Cl. E21B 33/138; C04B 12/00; B82Y 30/00

(52) U.S. Cl. 166/293; 106/638; 977/762

(57) ABSTRACT

A variety of methods and compositions are disclosed, including, in one embodiment, a method of cementing comprising: providing an aqueous dispersion comprising deagglomerated inorganic nanotubes and water; preparing a cement composition using the aqueous dispersion; introducing the cement composition into a subterranean formation; and allowing the cement composition to set. Another method comprises a method of cementing comprising: providing an ultrasonicated aqueous dispersion comprising deagglomerated nanoparticles, a dispersing agent, and water; preparing a cement composition using the aqueous dispersion; introducing the cement composition into is subterranean formation; and allowing the cement composition to set.

### BACKGROUND

Cement compositions may be used in a variety of subterranean operations. For example, in subterranean well construction, a pipe string (e.g., casing, liners, expandable tubulars, etc.) may be run into a well bore and cemented in place. The process of cementing the pipe string in place is commonly referred to as “primary cementing.” In a typical primary cementing method, a cement composition may be pumped into an annulus between the walls of the well bore and the exterior surface of the pipe string disposed therein. The cement composition may set in the annular space, thereby forming an annular sheath of hardened, substantially impermeable cement (i.e., a cement sheath) that may support and position the pipe string in the well bore and may bond the exterior surface of the pipe string to the subterranean formation. Among other things, the cement sheath surrounding the pipe string functions to prevent the migration of fluids in the annulus, as well as protecting the pipe string from corrosion. Cement compositions also may be used in remedial cementing methods, for example, to seal cracks or holes in pipe strings or cement sheaths, to seal highly permeable formation zones or fractures, to place a cement plug, and the like. Cement compositions may also be used in surface-cementing operations, such as construction cementing.

Once set, the cement sheath may be subjected to a variety shear, tensile, impact, flexural, and compressive stresses that may lead to failure of the cement sheath, resulting in, for example, fractures, cracks, and/or debonding of the cement sheath from the pipe string and/or the formation. This can lead to undesirable consequences including lost production, environmental pollution, hazardous rig operations resulting from unexpected fluid flow from the formation caused by the loss of zonal isolation, and/or hazardous production operations, among others. Cement failures may be particularly problematic in high temperature wells, where fluids injected into the wells or produced from the wells by way of the well bore may cause the temperature of any fluids trapped within the annulus to increase. Furthermore, high fluid pressures and/or temperatures inside the pipe string may cause additional problems during testing, perforation, fluid injection, and/or fluid production. If the pressure and/or temperature inside the pipe string increases, the pipe may expand and stress the surrounding cement sheath. This may cause the cement sheath to crack, or the bond between the outside surface of the pipe string and the cement sheath to fail, thereby breaking the hydraulic seal between the two. Furthermore, high temperature differentials created during production or injection of high temperature fluids through the well bore may cause fluids trapped in the cement sheath to thermally expand, causing high pressures within the sheath itself. Additionally, failure of the cement sheath also may be caused by, for example, forces exerted by shifts in subterranean formations surrounding the well bore, cement erosion, and repeated impacts from the drill bit and the drill pipe.

To improve the tensile strength of the set cement and at least partially counteract the impact of these forces on the cement sheath, high aspect ratio fibers such as glass fibers or organic fibers have been included in the cement compositions. However, the use of these high aspect ratio fibers may have drawbacks. For example, glass fibers generally cannot be added to the dry blend typically comprising the hydraulic cement and other dry additives since they break down under shear during preparation of the cement composition. By way of further example, organic fibers such as polypropylene fibers typically have temperature limitations that cause them to melt or soften at elevated temperatures, which may be problematic as higher temperatures can be encountered in subterranean cementing operations. In addition, the length of the high aspect ratio fibers that may be needed to enhance tensile strength is typically on the order of a few millimeters, presenting mixing problems during preparation of the cement composition. To ensure adequate mixability, the amount of fibers that can be added to a cement composition has been limited, for example, with upper limits in the range of 0.5% to 2% by weight of cement (“bwoc”).

### SUMMARY

An embodiment of the present invention provides a method of cementing comprising: providing an ultrasonicated aqueous dispersion comprising deagglomerated nanoparticles, a dispersing agent, and water; preparing a cement composition using the aqueous dispersion; introducing the cement composition into a subterranean formation; and allowing the cement composition to set.

Another embodiment of the present invention provides a method of cementing comprising: providing an aqueous dispersion comprising deagglomerated inorganic nanotubes and water; preparing a cement composition using the aqueous dispersion; and allowing the cement composition to set.

Another embodiment of the present invention provides a method of cementing comprising: providing a cement composition comprising a cement, deagglomerated halloysite nanotubes, a dispersing agent, and water, wherein deagglomerated halloysite nanotubes comprise halloysite nanotubes having a diameter in a range of from about 1 nanometer to about 300 nanometers and length in a range of from about 500 nanometers to about 10 microns; introducing the cement composition into a subterranean formation; and allowing the cement composition to set such that the cement composition alter setting for a period in a range of from about 24 hours to about 72 hours has a tensile strength that is increased by about 25% when compared to the same cement composition without deagglomeration of the halloysite nanotubes.

Another embodiment of the present invention provides a cement composition comprising a cement, deagglomerated inorganic nanotubes, and water.

The features and advantages of the present invention will be readily apparent to those skilled in the art. While numerous changes may be made by those skilled in the art, such changes are within the spirit of the invention.

### DESCRIPTION OF PREFERRED EMBODIMENTS

The present invention relates to subterranean cementing operations and, more particularly, in certain embodiments, to cement compositions comprising deagglomerated inorganic nanotubes and associated methods. There may be several potential advantages to the methods and compositions of the present invention, only some of which may be alluded to herein. One of the many potential advantages of the methods and compositions of the present invention is that the deagglomerated inorganic nanotubes, such as halloysite nanotubes may enhance mechanical properties of the cement compositions including enhancement of tensile strength. As a result, it is believed that cement compositions comprising deagglomerated inorganic nanotubes may have a reduced tendency to fail after setting in a well-bore annulus. Another potential advantage of the methods and compositions Of the present invention is that the deagglomerated inorganic nanotubes may be provided in an aqueous dispersion, thus allowing inclusion in a cement composition by use of standard mixing techniques

An embodiment of the cement compositions comprises cement, deagglomerated inorganic nanotubes, and water. Those of ordinary skill in the art will appreciate that the cement compositions generally should have a density suitable for a particular application. By way of example, the cement compositions may have a density in the range of from about 4 pounds per gallon (“lb/gal”) to about 20 lb/gal. In certain embodiments, the cement compositions may have a density in the range of from about 8 lb/gal to about 17 lb/gal. Embodiments of the cement compositions may be foamed or unfoamed or may comprise other means to reduce their densities, such as hollow microspheres, low-density elastic beads, or other density-reducing additives known in the art. In some embodiments, heavyweight additives (e.g., hematite, magnesium oxide, etc.) may be used for increasing the density of the cement compositions. Those of ordinary skill in the art, with the benefit of this disclosure, will recognize the appropriate density for a particular application.

Embodiments of the cement compositions may comprise cement. Any of a variety of cements suitable for use in subterranean cementing operations may be used in accordance with example embodiments. Suitable examples include hydraulic cements that comprise calcium, aluminum, silicon, oxygen and/or sulfur, which set and harden by reaction with water. Such hydraulic cements, include, but are not limited to, Portland cements, pozzolana cements, gypsum cements, high-alumina-content cements, slag cements, silica cements and combinations thereof. In certain embodiments, the hydraulic cement may comprise a Portland cement. Portland cements that may be suited for use in example embodiments may be classified as Class A, C, H and G cements according to American Petroleum Institute, API Specification for Materials and Testing for Well Cements, API Specification 10, Filth Ed., Jul. 1, 1990. In addition, in some embodiments, hydraulic cements suitable for use in the present invention may be classified as ASTM Type I, II, or III.

Embodiments of the cements composition may comprise deagglomerated inorganic nanotubes. The deagglomerated inorganic nanotubes may generally comprise inorganic nanotubes in the shape of a tubular, rod-like structure having a diameter in a range of from about 1 nanometer (“nm”) to several hundred nanometers, for example. In certain embodiments, the inorganic nanotubes may have a diameter of less than about 300 nm, less than about 200 nm, less than about 100 nm, in some embodiments, and less than 50 nm in additional embodiments. The inorganic nanotubes may have an aspect ratio (ratio of length to diameter) in a range of from about 1.25 to about 500. In certain embodiments, the inorganic nanotubes may have an aspect ratio in range of about 10 to about 200 and, in certain embodiments, from about 25 to about 100. The size of the inorganic nanotubes may be measured using any suitable technique. It should be understood that the measured size of the inorganic nanotubes may vary based on measurement technique, sample preparation, and sample conditions such as temperature, concentration, etc. One technique for measuring size of the nanotubes is Transmission Electron Microscope (TEM) observation. By this method, it is possible to determine the length and diameter of as single nanotube, bundle diameter, and number of nanotubes in a bundle. An example of suitable commercially available based on laser diffraction technique is Zetasizer Nano ZS supplied by Malvern instruments, Worcerstershire, UK. In some embodiments, the nanotubes are hollow. In some embodiments, the nanotubes are open at one or both ends. In some embodiments, the inorganic nanotubes may be single-walled or multi-walled nanotubes.

The inorganic nanotubes used in example embodiments may be any of variety of different nanomaterials that can be incorporated into the cement compositions. The inorganic nanotubes may be synthetic or naturally occurring. Examples of suitable inorganic nanotubes include nanotubes that comprise metal oxides, sulfides, selenides aluminosilicates, and combinations thereof. In certain embodiments, inorganic nanotubes may be synthesized from metal oxides, such as vanadium oxide, manganese oxide, titanium oxide, and zinc oxide. In additional embodiments, inorganic nanotubes may be synthesized from sulfides, such as tungsten (IV) disulfide, molybdenum disulfide, and tin (IV) disulfide. In some embodiments, the inorganic nanotubes may comprise aluminosilicates, such as halloysite, imogolite, cylindrite, boulangerite, and combinations thereof.

In certain embodiments, the inorganic nanotubes may comprise halloysite. The term “halloysite” refers to a naturally occurring aluminosilicate material comprising aluminum, silicon, hydrogen, and oxygen, which may be formed by hydrothermal alteration of aluminosilicate minerals over a period of time. Halloysite is mined in a number of locations, including in Wagon Wheel Gap, Colorado, USA, for example. The halloysite may be mined from the Earth and then processed to separate the halloysite that is present in tubular form from other forms and also from other minerals. Nanotubes comprising halloysite may have a diameter in a range of from about 1 nanometer to several hundred nanometers, for example. In certain embodiments, the nanotubes comprising halloysite may have a diameter of less than about 300 nm, less than about 200 nm, less than about 100 nm, or less than 50 nm. In embodiments, the nanotubes comprising halloysite may have a diameter in a range of from about 30 nm to about 70 nm. The nanotubes comprising halloysite may have a length in a range of from about 500 nm to a few microns or more. In some embodiments, the nanotubes comprising halloysite may have a length in a range of from about 500 nm to about 10 microns and, alternatively, from about 1 micron to about 3 microns. An example of a suitable nanotube comprising halloysite may have a diameter in a range of from about 30 nm to about 70 nm and to length in a range of from about 1 micron to about 3 microns.

Those of ordinary skill in the art, with the benefit of this disclosure, will appreciate that the inorganic nanotubes can form agglomerates made up of inorganic nanotubes. For example, agglomerates may form when dispersions of the nanotubes are stored for a period of time, such as from a few days to several weeks or more, or when the inorganic nanotubes are prepared, separated, and/or isolated in the solid form. It is believed that agglomerates of the nanotubes do not exhibit the same mechanical-property enhancement of the cement composition as the deagglomerated nanotubes presumable because contact area between the cement matrix and the deagglomerated form (for example, discrete nanotubes) is significantly higher than with the agglomerated form. Indeed, as shown below in Example 1, nanotubes that have not undergone a deagglomeration process do not show a significant increase in Brazilian tensile strength for the set cement composition. However, as shown in Examples 2-4, the use of deagglomerated nanotubes has been shown to increase the tensile strength of the set cement compositions.

Therefore, in accordance with embodiments of the present invention, the agglomerated inorganic nanotubes may be subjected to a deagglomeration process. The deagglomerated nanotubes may that be included in embodiments of the cement compositions. The term “deagglomerated” does not necessarily mean that the agglomerates comprising the inorganic nanotubes have been broken down completely into individual inorganic nanotubes. Rather, it means that the agglomerates comprising the nanotubes have undergone some type of processing to deagglomerate the agglomerates that may have formed during storage of nanotube dispersions or during production of the nanotubes, for example. In some embodiments, at least a portion or even substantially all of the inorganic nanotubes in the deagglomerated inorganic nanotubes are in the form of individual inorganic nanotubes. For example, at least about 50% or more of the inorganic nanotubes in the deagglomerated inorganic nanotubes may be in the form of individual inorganic nanotubes. In some embodiments, at least about 60%, at least about 70%, at least about 80%, or at least about 90% of the inorganic nanotubes in the deagglomerated inorganic nanotubes may be in the form of individual inorganic nanotubes.

The deagglomeration of the agglomerates of inorganic nanotubes may be achieved using in any of a variety of different processes suitable for the deagglomeration of nanotubes, including ultrasonication, mixing in a magnetically assisted fluidized bed, stirring in supercritical fluid, and magnetically assisted impaction mixing. In some embodiments, agglomerates of the inorganic nanotubes may be provided in a liquid and ultrasonicated using any known ultrasonication technique. The liquid may include water. Alternatively, the liquid may comprise alcohols, alcohol ethers, glycols, glycol ethers, and combinations thereof. In alternative embodiments, the inorganic nanotubes may be provided in a powdered form which may then be dispersed in a liquid (e.g., water) and then ultrasonicated. It is believed that the inorganic nanotubes may form agglomerates in the powder and/or after dispersion in the liquid. As will be appreciated by those of ordinary skill in the art, with the benefit of this disclosure, the ultrasonication may deagglomerate the inorganic nanotubes, thus breaking the agglomerates down into smaller-sized particles, such as individual inorganic nanotubes. In some embodiments, the agglomerates are ultrasonicated for a period of time is a range of from about 10 minutes to about 1 hour or more. For example, the agglomerates may be ultrasonicated for about 20 minutes to about 40 minutes. In one embodiment, the agglomerates may be ultrasonicated for about 30 minutes. In some embodiments, the ultrasonication may include use of an ultrasonicator, such as an ultrasonic bath. The operating frequency of the ultrasonicator may range from about 20 kHz to about 80 kHz and be 40 kHz in one embodiment. The resulting ultrasonicated dispersion may then be stirred for a period of time, for example, to produce a more homogenous mixture. In some embodiments, the ultrasonicated dispersion may be stirred for about 1 minute to a few hours. For example, the ultrasonicated dispersion may be stirred for about 30 minutes to about 1 hour. In some embodiments, stirring may not be needed.

To facilitate stabilization of the deagglomerated form in the liquid, a dispersing agent may be included in the liquid. For example, a dispersion comprising a liquid, the inorganic nanotube agglomerates, and the dispersing agent may be provided and then ultrasonicated, for example, as previously described. In some embodiments, the dispersing agent may be added to the dispersion after ultrasonication or even during ultrasonication. The dispersing agent generally should facilitate deagglomeration and/or prevent the undesirable reagglomeration of larger inorganic nanotube agglomerates. It is believed that the inclusion of the dispersing agent may increase the shelf life of the ultrasonicated dispersion comprising the deagglomerated nanotubes, thus allowing the ultrasonicated dispersion to be stored prior to use. For example, it is believed that the ultrasonicated dispersion may be stored for about 1 hour to several weeks or more without undesired reagglomeration such that the inorganic nanotubes may be used to provide mechanical-property enhancement for a cement composition after storage. In some embodiments, the ultrasonicated dispersion may be stored for at least 1 day, at least about 1 week, at least about 1 month, or longer. Where used, the dispersing agent may be included in an amount, in a range of from about 1% to about 20%, alternatively from about 3% to about 15% and alternatively from about 5% to about 10%, all percentages being by weight of the inorganic nanotubes. One of ordinary skill in the art, with the benefit of this disclosure, should recognize the appropriate amount of the dispersing agent to include for a chosen application.

Examples of suitable dispersing agents include water-soluble low-molecular-weight components that may be anionic, non-ionic, or amphoteric. In some embodiments, the dispersing agent may include an anionic polymer comprising a carboxylic group and/or a sulfonate group. Without being limited by theory, the anionic polymers generally should disperse the inorganic nanotubes and prevent reagglomeration by means of electrostatic as well as steric repulsion. In some embodiments, comb/branched polycarboxylates such as comb/branched polycarboxylate ethers may be used to disperse the inorganic nanotubes and/or prevent reagglomeration. For example, suitable polycarboxylate ethers include MELFLUX® Dispersing agent (BASF Chemical Company), ETHACRYCL® M Dispersing agent (Coatex, LLC) and MIGHTY EG® Dispersing agent (Kao Specialties Americas, LLC). In some embodiments, the carboxylated dispersant may be non-polymeric, for example, fatty acids or their salts such as linoleic acid, stearic acid, and the like. In some embodiments, sulfonated water-soluble anionic polymers such as polystyrene sulfonate can be used. An example of a suitable polystyrene sulfonate is Gel Modifier 750L (Halliburton Energy Services). Other suitable anionic polymeric or monomeric dispersants include those containing phosphate or phosphonate anionic groups. Examples of non-ionic dispersants include polyethylene glycols, ethylene oxidelpropyleric oxide copolymers (block or random) and polyvinyl alcohol and any combination thereof. In some embodiments, the dispersants may be surface active. It should be possible for one skilled in the art to select as proper dispersant depending the dispersion medium, and the chemical composition of particular inorganic nanotube.

In some embodiments, the deagglomerated inorganic nanotubes function as a mechanical property enhancer. For example, deagglomeration of the inorganic nanotubes can be used to enhance the Brazilian tensile strength of the set cement composition. By way of example, the Brazilian tensile strength of cement compositions comprising deagglomerated inorganic nanotube may be increased by at least about 25% in one embodiment, at least about 50% in another embodiment, and at least about 100% in yet another embodiment, as compared to the same cement composition that does not contain the inorganic nanotubes or in which the inorganic nanotubes were not deagglomerated. In some embodiments, the cement composition has a Brazilian tensile strength after setting of at least about 400 psi, at least about 600 psi in some embodiments, and at least about 800 in alternative embodiments. In some embodiments, the cement composition has as Brazilian tensile strength in a range of from about 400 psi to about 850 psi. As described herein, the Brazilian tensile strength is measured at a specified time after the cement composition has been mixed and then allowed to set under specified temperature and pressure conditions for a period of time. For example, Brazilian tensile strength can be measured after a period of in a range of from about 24 hours to about 96 hours. The Brazilian tensile strengths can be measured as specified in ASTM C496/C496M in which the splitting tensile strength is measured for a cylindrical concrete specimen.

In general, the deagglomerated inorganic nanotubes may be included in the cement composition in an amount sufficient to provide the desired mechanical property enhancement, for example. In some embodiments, the deagglomerated inorganic nanotubes may be present in an amount in a range of from about 0.01% bwoc to about 10% bwoc. In particular embodiments, the deagglomerated inorganic nanotubes may be present in an amount ranging, between any of and/or including any of about 0.01%, about 0.05%, about 0.1%, about 0.5%, about 1%, about 2%, about 3%, about 4%, about 5%, about 6%, about 7%, about 8%, about 9%, or about 10%, all percentages bwoc. One of ordinary skill in the art, with the benefit of this disclosure, should recognize the appropriate amount of the deagglomerated inorganic nanotubes to include for a chosen application.

Embodiments of the cement compositions may comprise water. The water may be fresh water or salt water. Salt water generally may include one or more dissolved salts therein and may be saturated or unsaturated as desired for a particular application. Seawater or brines may be suitable for use in embodiments of the present invention. Further, the water may be present in an amount sufficient to form a pumpable slurry. In some embodiments, the water may be included in the settahie compositions of the present invention in an amount in the range of from about 40% bwoc to about 200% bwoc. For example, the water may be present in an amount ranging between any of and/or including any of about 50%, about 75%, about 100%, about 125%, about 150%, or about 175%, all percentages bwoc. In specific embodiments, the water may be included in an amount in the range of from about 40% bwoc to about 150% bwoc. One of ordinary skill in the art, with the benefit of this disclosure, will recognize the appropriate amount of water to include for a chosen application.

Other additives suitable for use in subterranean cementing operations also may be added to embodiments of the cement. compositions. Examples of such additives include, but are not limited to, strength-retrogression additives, set accelerators, weighting agents, lightweight additives, gas-generating additives, mechanical property enhancing additives, lost-circulation materials, filtration-control additives, dispersing agents, fluid loss control additives, defoaming agents, foaming agents, thixotropic additives, and combinations thereof. By way of example, the cement composition may be a foamed cement composition further comprising a foaming agent and a gas. Specific examples of these, and other, additives include crystalline silica, amorphous silica, fumed silica, salts, fibers, hydratable clays, calcined shale, vitrified shale, microspheres, fly ash, slag, diatomaceous earth, metakaolin, rice husk ash, natural pozzolan, zeolite, cement kiln dust, lime, elastomers, resins, latex, combinations thereof, and the like. A person having ordinary skill in the art, with the benefit of this disclosure, will readily be able to determine the type and amount of additive useful for a particular application and desired result.

The components of the cement compositions comprising deagglomerated inorganic nanotubes may be combined in any order desired to form a cement composition that can be placed into a subterranean formation. The components of the cement compositions comprising deagglomerated inorganic. nanotubes may be combined using any mixing device compatible with the composition, including, as bulk mixer, for example. In some embodiments, a dispersion comprising the deagglomerated nanotubes may be provided and combined with the water before it is mixed with the cement to form the cement composition. In certain embodiments, the dispersion may be an ultrasonicated dispersion that further comprises a dispersing agent.

As will be appreciated by those of ordinary skill in the art, embodiments of the cement compositions of the present invention may be used in a variety of subterranean operations, including primary and remedial cementing. In some embodiments, a cement composition may be provided that comprises cement, deagglomerated nanotubes, and water. The cement composition may be introduced into a subterranean formation and allowed to set therein. As used herein, introducing the cement composition into a subterranean formation includes introduction into any portion of the subterranean formation, including, without limitation, into a well bore drilled into the subterranean formation, into a near well bore region surrounding the well bore, or into both.

In primary-cementing embodiments, for example, embodiments of the cement composition may be introduced into a well-bore annulus such as a space between a wall of a well bore and a conduit (e.g., pipe strings, liners) located in the well bore, the well bore penetrating the subterranean formation. The cement composition may be allowed to set to form an annular sheath of hardened cement in the well bore annulus. Among other things, the set cement composition may form a barrier, preventing the migration of fluids in the well bore. The set cement composition also may, for example, support the conduit in the well bore.

In remedial-cementing embodiments, a cement composition may be used, for example, in squeeze-cementing operations or in the placement of cement plugs. By way of example, the cement composition may be placed in a well bore to plug an opening, such as a void or crack, in the formation, in a gravel pack, in the conduit, in the cement sheath, and/or a microannulus between the cement sheath and the conduit.

While the preceding description is directed to the use of deagglomerated inorganic nanotubes, those of ordinary skill in the art, with the benefit of this disclosure, should appreciate that it may be desirable to utilize other types of deagglomerated nanoparticles in accordance with embodiments of the present invention. For example, by use of deagglomerated nanoparticles the nanoparticles included in a cement composition may have a higher surface exposed surface area, thus providing increase performance improvement to cement compositions. Examples of such nanoparticles may include nano-clay, nano-hydraulic cement, nano-alumina, nano-zinc oxide, nano-boron, nano-iron oxide, and combinations thereof. In some embodiments, nanosilica dispersions are not included. In general, the nanoparticles may be defined as having at least one dimension (e.g., length, width, diameter) that is less than 100 nanometers. For example, the nanoparticles may have at least one dimension that is in a range of from about 1 nm to less than 100 nanometers. In particular embodiments, the nanoparticles may have at least one dimension ranging between any of and/or including any of about 1 nm, 10 nm, about 50 nm, about 60 nm, about 70 nm, about 80 nm, about 90 nm, or about 99 nm. In addition, the nanoparticles may be configured in any of a variety of different shapes in accordance with embodiments of the present invention. Examples of suitable shapes include nanoparticles in the general shape of platelets, shavings, flakes, rods, strips, spheroids, toroids, pellets, tablets, or any other suitable shape.

### EXAMPLES

To facilitate a better understanding of the present invention, the following examples of certain aspects of some embodiments are given. In no way should the following examples be read to limit, or define, the entire scope of the invention.

### Example 1

The following example was performed to evaluate the effect of the addition of halloysite nanotubes to a cement composition. Three sample cement compositions, designated Samples 1-3, were prepared that had a density of 15.8 lb/gal and comprised Portland Class G cement in an amount of 100% bwoc, water in an amount of 5.09 gallons per 94-pound sack of the 4cement (“gal/sk”), and a cement dispersing agent (CFR-3™ cement friction reducer from Halliburton Energy Services, Inc.) in an amount of 0.2% bwoc. Sample 1 was a control and did not include a tensile strength enhancer. Sample 2 further included glass fibers (WellLife® 734 Additive, from Halliburton Energy Services), in an amount of 1.0% bwoc, as a tensile strength enhancer. The glass fibers had a length of 3 mm. Sample 3 included halloysite nanotubes (Halloysite from Sigma-Aldrich Co, LLC), in an amount of 1.0% bwoc, as a tensile strength enhancer.

The physical properties of the halloysite nanotubes tested in this example are given below:
Chemical Formula: Al₂Si₂O₅(OH)₄
Molecular Weight: 294.19 g/mol
Diameter>Length: 30-70 nanometers×1-3 microns
Surface Area: 64 m²/g
Pore Size: 1.26-1.34 mL/g
Density: 2.53 g/cm³
   The halloysite nanotubes were provided in a dry, powder from. Prior to mixing with cement, the halloysite nanotubes were dispersed in water by stirring for 2 hours. To this dispersion, the Portland Class G cement was added. The cement dispersing agent was provided in a powder form and was dry blended with the cement prior to mixing with the water.

After preparation, each sample cement composition was then cured for 72 hours in a 2″×5″ metal cylinder in a water bath at 180° F. and atmospheric pressure to form set cement cylinders. The Brazilian tensile strength (ASTM C496/C496M) for each set cement cylinder was then determined. The results from the tensile strength tests are set forth in the table below. The percent increase reported is the difference between the tensile strength for the particular sample and the tensile strength for Sample 1 (control) divided by the tensile strength for Sample 1. The reported values in the table below are an average value for testing of 2 cement cylinders tzar each sample.

TABLE 1

| | Tensile Strength | | | |
|---|---|---|---|---|
| | Enhancer | | Brazilian TS | |
| | Type | % bwoc | (psi) | % Increase |
| Sample 1 | Control | — | 346.34 | — |
| Sample 2 | Glass Fibers | 1.0 | 627.92 | 81.2 |
| Sample 3 | Halloysite Nanotubes | 1.0 | 370.49 | 6.97 |

As indicated in the table above. Sample 3 with the halloysite nanotubes did not exhibit a significant improvement in tensile strength in comparison to the control sample. In contrast. Sample 2 with the glass fibers exhibited an 81.2% increase in tensile strength.

### Example 2

The following example was performed to further evaluate the effect of the addition of halloysite nanotubes to a cement composition. In particular, this example evaluated the impact of the ultrasonication of halloysite nanotubes on the tensile strength of the cement composition.

Three sample cement compositions, designated Samples 4-6, were prepared that had a density of 15.8 lb/gal and comprised Portland Class G cement in an amount of 100% bwoc, water in an amount of 5.09 gal/sk, a cement dispersing agent (CFR-3™ cement friction reducer from Halliburton Energy Services, Inc.) in an amount of 0.2% bwoc, and halloysite nanotubes. The amount of the halloysite nanotubes (Halloysite from Sigma-Aldrich Co. LLC) in Samples 4-6 was varied from 1.0% bwoc to 2.0% bwoc as indicated in the table below.

In this example, a different technique was used for slurry preparation than was performed in the preceding example. As described above, the halloysite nanotubes were provided in a dry, powder from. Prior to mixing with cement, the halloysite nanotubes were dispersed in water and then ultrasonicated for 30 minutes. The ultrasonication used an ultrasonic water bath having an operating frequency of 40 kHz for the ultrasonicator. To this ultrasonicated dispersion, the Portland Class G cement was added. The cement dispersing agent was provided in a powder form and was dry blended with the cement prior to mixing with the water.

After preparation, each sample cement composition was then cured for 72 hours in a 2″×5″ metal cylinder in a water bath at 180° F. and atmospheric pressure to form set cement cylinders. The Brazilian tensile strength (ASTM C496/C496M) for each set cement cylinder was then determined. The results from the tensile strength tests are set forth in the table below. The percent increase reported is the difference between the tensile strength for the particular sample and the tensile strength for Sample (control) divided by the tensile strength for Sample 1. The reported values in the table below are an average value for testing of 2 cement cylinders for each sample.

TABLE 2

| | Halloysite | | |
|---|---|---|---|
| | Nanotubes (% bwoc) | Brazilian TS (psi) | % Increase |
| Sample 4 | 1.0 | 469.08 | 35.43 |
| Sample 5 | 1.5 | 613.50 | 77.13 |
| Sample 6 | 2.0 | 380.35 | 9.81 |

As indicated in the table above, a significant increase in tensile strength was observed for Sample 4 and Sample 5 as compared to Sample 1 (control) from the preceding example that did not include a tensile strength enhancer. For example, Sample 4 that contained halloysite nanotubes in the amount of 1.0% bwoc had a tensile strength increase of 35.43%. By way of further example, Sample 5 that contained halloysite nanotubes in the amount of 1.5% bwoc had a tensile strength increase of 77.13% bwoc. This indicates that ultrasonication of the halloysite nanotubes likely broke down agglomerates of the halloysite nanotubes into individual halloysite nanotubes, thus providing significant increases in tensile strength when the halloysite nanotubes were used in the cement composition.

### Example 3

In the following example, the tests performed in Example 2 were repeated except that the dispersing agent (CFR-3™ cement friction reducer) was replaced with an anionic acrylate polymeric dispersing agent (Coatex XP 1629 from Coatex LLC). The dispersing agent was added to the ultrasonicated dispersion in an amount of 0.05 gal/sk before addition of the cement. The testing was also repeated for Sample 1 (control) from Example 1 with replacement of the dispersing agent (CFR-3™ cement friction reducer) with the anionic acrylate polymeric dispersing agent.

The results from the tensile strength tests are set forth in the table below. The percent increase reported is the difference between the tensile strength for the particular sample and the tensile strength for Sample 7 (control) divided by the tensile strength for Sample 7. The reported values in the table below are an average value for testing of 2 cement cylinders for each sample.

TABLE 3

| | Halloysite | | |
|---|---|---|---|
| | Nanotubes (% bwoc) | Brazilian TS (psi) | % Increase |
| Sample 7 | Control | 361.23 | — |
| Sample 8 | 1.0 | 558.96 | 54.73 |
| Sample 9 | 1.5 | 668.92 | 85.17 |
| Sample 10 | 2.0 | 574.21 | 58.95 |

As indicated in the table above, a significant increase in tensile strength was observed for Samples 8-10 as compared to Sample 7 (control) that did not include a tensile strength enhancer. In particular, Samples 8-10 had tensile-strength increases ranging from 54.73% to 85.17%. This indicates that ultrasonication of the halloysite nanotubes likely broke down agglomerates of the halloysite nanotubes, thus providing significant increases in tensile strength when the halloysite nanotubes were used in the cement composition.

### Example 4

The following example was performed to further evaluate the effect of the addition of halloysite nanotubes to a cement composition. In particular, the example evaluated the impact of the ultrasonication of halloysite nanotubes in the presence of a dispersing agent and compared the performance of halloysite nanotubes with kaolinite, another aluminosilicate material.

Six sample cement compositions, designated Samples 11-17, were prepared that had a density of 15.8 lb/gal and comprised Portland Class G cement in an amount of 100% bwoc, water in an amount of 5.09 gal/sk, and a dispersing agent. Samples 13-15 and 17 included halloysite nanotubes (Halloysite from Sigma-Aldrich Co. LLC) in an amount ranging from 0.4% bwoc to 2.5% bwoc. Sample 12 included kaolin (Nano Caliber-100 from English India Clays Ltd.) in an amount of 1.5% bwoc. The kaolinite had a thickness of less than 10 nm and width of 150-200 nm. Samples 11 and 16 were controls that did not include an aluminosilicate. The dispersing agent used in Samples 11-15 was an anionic acrylate polymeric dispersing agent (Coatex XP 1629 from Coatex LLC) in an amount of 0.05 gal/sk. The dispersing agent used in Samples 16 and 17 was a polystyrene sulfonate (Gel Modifier 750L from Halliburton Energy Services, Inc.) in an amount of 0.03 gal/sk.

In this example, a different technique was used for slurry preparation than was performed in the preceding examples. As described above, the halloysite nanotubes were provided in a dry, powder form. Prior to mixing with cement, the halloysite nanotubes were dispersed in water and then ultrasonicated for 30 minutes. The ultrasonication used an ultrasonic water bath having an operating frequency of 40 kHz for the ultrasonicator. The dispersing agent was provided in a liquid form and added to the water prior to ultrasonication such that the ultrasonication of the halloysite nanotubes was performed in the presence of the dispersing agent. To this ultrasonicated dispersion, the Portland Class G cement was added. The samples with kaolin were also prepared using this technique.

After preparation, each sample cement composition was stored for 30 minutes and then cured for 72 hours in a 2″×5″ metal cylinder in a water bath at 180° F. and atmospheric pressure to form set cement cylinders. The Brazilian tensile strength (ASTM C496/C496M) for each set cement cylinder was then determined. The results from the tensile strength tests are set forth in the table below. The percent increase reported is the difference between the tensile strength for the particular sample and the tensile strength for the control (Sample 11 or 16) divided by the tensile strength for the control (Sample 11 or 16). The reported values in the table below are an average value for testing of 2 cement cylinders for each sample.

TABLE 4

| | Aluminum Silicate | | | | | |
|---|---|---|---|---|---|---|
| | | % | Dispersing Agent | | Brazilian | % |
| | Type | bwoc | Type | gal/sk | TS (psi) | Increase |
| Sample 11 | Control | — | Coatex | 0.05 | 356.44 | — |
| Sample 12 | Kaolinite | 1.5 | Coatex | 0.05 | 330.37 | −7.31 |
| Sample 13 | Halloysite | 0.4 | Coatex | 0.05 | 536.67 | 50.56 |
| | Nanotubes | | | | | |
| Sample 14 | Halloysite | 1.5 | Coatex | 0.05 | 837.22 | 134.88 |
| | Nanotubes | | | | | |
| Sample 15 | Halloysite | 2.5 | Coatex | 0.05 | 485.28 | 36.14 |
| | Nanotubes | | | | | |
| Sample 16 | Control | — | Gel | 0.03 | 338.97 | — |
| | | | Modifier | | | |
| | | | 750L | | | |
| Sample 17 | Halloysite | 1.5 | Gel | 0.03 | 704.36 | 107.79 |
| | Nanotubes | | Modifier | | | |
| | | | 750L | | | |

As indicated in the table above, as significant increase in tensile strength was observed for Samples 13-15 and 17 as compared to the control samples (Samples 11 and 16) from the preceding example that did not include a tensile strength enhancer. In particular, tensile-strength increases ranging from 36.14% to 134.88% were observed. The ultrasonication of the halloysite nanotubes in the presence of the dispersing agent appears to have increased tensile strength of the set cement cylinders as tensile strength increases over 100% were observed for Samples 13 and 16. In addition, as further indicated in the table above, the kaolin was not observed to have a positive impact on tensile strength.

### Example 5

The following example was performed to evaluate the effect of the addition of halloysite nanotubes on a cement composition. In particular, the example evaluated the compressive strength development of cement compositions comprising halloysite nanotubes.

For this example, portions of Samples 1-3 from Example 1 were used. As set forth above, each sample composition had as density of 15.8 lb/gal and comprised Portland Class G cement in an amount of 100% bwoc, water in an amount of 5.09 gal/sk, and a cement dispersing agent (CFR-3™ cement friction reducer) in an amount of 0.2% bwoc. Sample 1 was a control and did not include a tensile strength enhancer. Sample 2 further included glass fibers (Well Life® 734 Additive), in an amount of 1.0% bwoc, as a tensile strength enhancer. Sample 3 included halloysite nanotubes (Signa-Aldrich Co. LLC), in an amount of 1.0% bwoc, as a tensile strength enhancer.

After preparation, the compressive strength over time was determined for each sample cement composition using an Ultrasonic Cement Analyzer (UCA), available from Fann Instrument Company, Houston, Tex. In the UCA, the sample cement compositions were cured at 180° F. while maintained at 3000 psi. The results from the UCA tests are set forth below.

TABLE 5

| | Tensile Strength | | Time for | Time for | 24-Hour |
|---|---|---|---|---|---|
| | Enhancer | | 50 psi | 500 psi | Compressive |
| | Type | % bwoc | (hr:min) | (hr:min) | Strength (psi) |
| Sample 1 | Control | — | 2:03 | 2:38 | 2517 |
| Sample 2 | Glass | 1.0 | 1:57 | 2:27 | 2834 |
| | Fibers | | | | |
| Sample 3 | Halloysite | 1.0 | 1:51 | 2:23 | 2704 |
| | Nanotubes | | | | |

As indicated in the table above, Sample 3 with the halloysite nanotubes did not exhibit a significant impact on compressive strength development as compared Sample 1 (control) and Sample 2 containing the glass fibers.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Although individual embodiments are discussed, the invention covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present invention. If there is any conflict in the usages of a word or term in this specification and one or more patent(s) or other documents that may be incorporated herein by reference, the definitions that are consistent with this specification should be adopted.

What is claimed is:

1. A method of cementing comprising:
providing an aqueous dispersion comprising deagglomerated inorganic nanotubes and water;
preparing a cement composition using the aqueous dispersion; and
allowing the cement composition to set.

2. The method of claim 1 wherein the deagglomerated inorganic nanotubes were deagglomerated by a process comprising ultrasonication, mixing in a magnetically assisted fluidized bed, stirring in a supercritical fluid, or magnetically assisted impaction mixing.

3. The method of claim 1 wherein the aqueous dispersion is an ultrasonicated aqueous dispersion further comprising a dispersing agent.

4. The method of claim 3 wherein the dispersing agent is present in the aqueous dispersion in an amount in a range of from about 1% to about 20% by weight of the inorganic nanotubes, and wherein the dispersing agent comprises at least one component selected from the group consisting of an anionic polymer comprising a carboxylic group, an anionic polymer comprising as sulfonate group, a comb/branched polycarboxylate ether, a fatty acid, linoleic acid, stearic acid, a sulfonated water-soluble anionic polymer, polystyrene sulfonate, a polyethylene glycol, ethylene oxide/propylene oxide block copolymer, polyvinyl alcohol, and any combination thereof.

5. The method of claim 1 wherein the deagglomerated inorganic nanotubes comprise at least one material selected from the group consisting of as metal oxide, a sulfide, a selenide, an aluminosilicate, and any combination thereof.

6. The method of claim 1 wherein the deagglomerated inorganic nanotubes comprise at least one aluminosilicate selected from the group consisting of halloysite, imogolite, cylindrite, boulangerite, and any combination thereof.

7. The method of claim 1 further comprising introducing the cement composition into a subterranean formation.

8. The method of claim 1 wherein the cement composition is used in primary cementing.

9. The method of claim 1 wherein the aqueous dispersion comprising the deagglomerated inorganic nanotubes was stored for at least 1 day prior to preparing the cement composition.

10. A method of cementing comprising:
providing an ultrasonicated aqueous dispersion comprising deagglomerated nanoparticles, a dispersing agent, and water;
preparing a cement composition using the aqueous dispersion;
introducing the cement composition into a subterranean formation; and
allowing the cement composition to set.

11. The method of claim 10 wherein the deagglomerated nanoparticles comprise at least one material selected from the group consisting of nano-clay, nano-hydraulic cement, nano-silica, nano-alumina, nano-zinc oxide, nano-boron, nano-iron oxide, and combinations thereof.

12. The method of claim 10 wherein the deagglomerated nanoparticles comprise inorganic nanotubes.

13. The method of claim 12 wherein the inorganic nanotubes comprise at least one material selected from the group consisting of a metal oxide, a sulfide, a selenide, an aluminosilicate, and any combination thereof.

14. The method of claim 12 wherein the inorganic nanotubes comprise at least one aluminosilicate selected from the group consisting of halloysite, imogolite, cylindrite, boulangerite, and any combination thereof.

15. The method of claim 12 wherein the inorganic nanotubes comprise halloysite.

16. The method of claim 12 wherein the inorganic nanotubes have a diameter of less than about 300 nanometers and a length in a range of from about 500 nanometers to about 10 microns.

17. The method of claim 12 wherein the inorganic nanotubes have a diameter in a range of from about 30 nanometers to about 70 nanometers, a length in a range of from about 1 micron to about 3 microns.

18. The method of claim 10 wherein the dispersing agent is present in the aqueous dispersion in an amount in a range of from about 1% to about 20% by weight of the nanoparticles, and wherein the dispersing agent comprises at least one component selected from the group consisting of an anionic polymer comprising a carboxylic group, an anionic polymer comprising a sulfonate group, a comb/branched polycarboxylate ether, a fatty acid, linoleic acid, stearic acid, a sulfonated water-soluble anionic polymer, polystyrene sulfonate, a polyethylene glycol, ethylene oxide/propylene oxide block copolymer, polyvinyl alcohol, and any combination thereof.

19. The method of claim 10 wherein at least about 50% of the deagglomerated nanoparticles are in the form of individual nanoparticles.

20. The method of claim 10 wherein the ultrasonicated aqueous dispersion was prepared by a process comprising ultrasonication for a period of time in a range of from about 10 minutes to about 1 hour.

21. The method of claim 20 wherein the ultrasonicated aqueous dispersion was prepared by a process further comprising stirring the ultrasonicated dispersion for a period of time in a range of 1 minute to about 1 hour after the step of ultrasonication.

22. The method of claim 20 wherein deagglomeration of the inorganic nanoparticles increases the Brazilian tensile strength of the cement composition by at least about 25% as measured after a period of in a range of from about 24 hours to about 96 hours when compared to use of the inorganic nanoparticles without deagglomeration.

23. The method of claim 10 wherein the deagglomerated nanoparticles are present in the cement composition in an amount a range of from about 0.01% to about 10% by weight of hydraulic cement, the cement composition further comprising the hydraulic cement.

24. The method of claim 10 wherein the cement composition is used in primary cementing.

25. The method of claim 10 further comprising introducing the cementing composition into a well-bore annulus between a wall of a well bore and a conduit located in the well bore.

26. A method of cementing comprising:
providing a cement composition comprising a cement, deagglomerated halloysite nanotubes, a dispersing agent, and water, wherein deagglomerated halloysite nanotubes comprise halloysite nanotubes having a diameter in a range of from about nanometer to at 300 nanometers and length in a range of from about 500 nanometers to about 10 microns;
introducing the cement composition into a subterranean formation; and
allowing the cement composition to set such that the cement composition after setting for a period in a range of from about 24 hours to about 72 hours has a tensile strength that is increased by at least 25% when compared to the same cement composition without deagglomeration of the halloysite nanotubes.

27. The method of claim 26 wherein the dispersing agent comprises at least one component selected from the group consisting, of an anionic polymer comprising a carboxylic group, an anionic polymer comprising as sulfonate group, a comb/branched polycarboxylate ether, a fatty acid, linoleic acid, stearic acid, a sulfonated water-soluble anionic polymer, polystyrene sulfonate, a polyethylene glycol, ethylene oxides/propylene oxide block copolymer, polyvinyl alcohol, and any combination thereof.

28. The method of claim 26 wherein at least about 50% of the deagglomerated halloysite nanotubes are in the form of individual halloysite nanotubes.

29. The method of claim 26 wherein deagglomeration of the halloysite nanotubes increases the Brazilian tensile strength of the cement composition by at least about 25% as measured after a period of in a range of from about 24 hours to about 96 hours.

30. The method of claim 26 wherein the cement composition is used in primary cementing.

31. A cement composition comprising:
a cement;
deagglomerated inorganic nanotubes; and
water.
